(19) United States
(12) Patent Application Publication
(10) Pub. No.: US 2006/0177093 A1
(43) Pub. Date: Aug. 10, 2006

(54) Sheet identifying device and method

(76) Inventors: Satoru Tsurumaki, Saitama (JP); Seiji Takamatsu, Saitama (JP); Yasuyuki Kimura, Saitama (JP)

Correspondence Address: FISH & RICHARDSON P.C., P.O. BOX 1022, MINNEAPOLIS, MN, 55440-1022, US

(21) Appl. No.: 10/547,035

(22) PCT Filed: Feb. 27, 2004
(86) PCT No.: PCT/JP04/02434

§ 371 Date: Aug. 26, 2005

(30) Foreign Application Priority Data
Feb. 28, 2003 (JP) 2003-053504

(51) Int. Cl. G06K 9/00; H04L 9/00

(52) U.S. Cl. 382/100; 713/176

(57) ABSTRACT

A sheet identifying device and method for identifying the kind of sheet or checking whether a sheet is a genuine or counterfeit one correctly without influence of the state of the sheet. Data on the image of a sheet is acquired, and the image data is binarized according to a watermark region extraction threshold. Image data on the watermark region is extracted according to the sheet image data. The watermark region image data is binarized according to a watermark pattern extraction threshold. The center of gravity of the watermark region is calculated on the basis of the watermark region image data. The watermark region image data is divided into divisions using the center of gravity of the watermark region as the origin. From the watermark region image data, image data on a predetermined specific region is extracted. Values of distinctive features such as the center of gravity and area of the watermark pattern included in the specific region image data are extracted. According to the value of distinctive feature, the kind of the sheet is identified and the sheet is authenticated.

### TECHNICAL FIELD

The present invention relates to a sheet identifying device and method, and more particularly to a sheet identifying device and a method for identifying the kind of sheet and checking whether the sheet is a genuine or a counterfeit one by extracting feature of the sheet as an image.

### BACKGROUND ART

Generally, identifying the kind of a sheet such as paper money, check, or merchandise bond and checking whether the sheet is a genuine or a counterfeit one are conducted by using a magnetic or optical sensor and extracting magnetically or optically a feature of the sheet inserted by a user.

In extracting an optical feature of the sheet with an optical sensor, design, size, and direction of the sheet are extracted using a transmission type optical sensor or a reflection type optical sensor, thereby acquiring image patterns thereof, and the acquired image patterns are compared with the reference patterns of the genuine sheet of each type in order to identify the kind of the inserted sheet and check whether it is a genuine or a counterfeit one.

In particular, when a transmission type optical sensor is used to identify the kind of the inserted sheet and check whether it is a genuine or a counterfeit one, a light-emitting device and a light-receiving device are disposed at the prescribed distance from each other, a sheet is transported between the light-emitting device and the light-receiving device, a specific pattern is extracted, and the extracted specific pattern is compared with a reference specific pattern of the genuine sheet stored and retained in a advance, thereby identifying the kind of the inserted sheet and checking whether it is a genuine or a counterfeit one.

For example, Japanese Patent Application Laid-open No. 2002-33912 discloses a conventional method for detecting a watermark pattern, which is an example of specific pattern, where the presence or absence of a watermark pattern is established by binarizing the image of a watermark region where the watermark pattern is present and projecting the binarized image data into any direction.

FIG. 7 illustrates outlines of the conventional method for detecting a watermark pattern.

FIG. 7(a) illustrates an outline of the method for detecting a watermark pattern 23 in the case where neither wrinkles nor stains (261, 262, 263) are present on the sheet. In an image data 20 of a binarized watermark region 21 shown in FIG. 7(a), the watermark region 21 is a white pixel (pixel value is “0”) and the watermark pattern 23 is black pixels (pixel value is “1”). If the pixel count for black pixels in the image data 20 is projected in the X direction, a graph 271 shown in FIG. 7(a) is generated and the pixel count and the presence or absence of the watermark pattern 23 is checked by detecting the pixel count for black pixels per Y coordinate from the graph 271.

FIG. 7(b) illustrates an outline of the method for detecting a watermark pattern 23 in the case where wrinkles and stains (261, 262, 263) are present on the sheet. In an image data 20 of a binarized watermark region 21 shown in FIG. 7(b), the watermark region 21 is a white pixel and the watermark pattern 23 and wrinkles and stains (261, 262, 263) are black pixels. If the pixel count for black pixels in the image data 20 is projected in the X direction, a graph 272 shown in FIG. 7(b) is generated. However, in graph 272, wrinkles and stains (261, 262, 263) produce a significant effect and the presence or absence of the watermark pattern 23 is sometimes erroneously established.

In other words, the conventional method for detecting the watermark pattern is easily influenced by the state of the sheet, such as wrinkles or stains, and it is difficult to identify the kind of the sheet or check whether the sheet is a genuine or a counterfeit one.

### DISCLOSURE OF THE INVENTION

Accordingly, it is an object of the present invention to provide a sheet identifying device and method that can accurately identify the kind of the sheet or check whether the sheet is a genuine or a counterfeit one, without the being influenced by the state of the sheet.

In order to attain this object, the invention of claim 1 is characterized by comprising a transmission type optical sensor that irradiates a sheet with transmission light and acquiring an image of the sheet based on transmitted light; watermark region extracting means for extracting an image of a watermark region where a watermark pattern is present from the image acquired with the transmission type optical sensor; image processing means for dividing the image of the watermark region extracted with the watermark region extracting means into a plurality of regions; and identification means for identifying the sheet based on a value of distinctive feature of the image contained in a specific region among the plurality of regions obtained by dividing with the image processing means.

Furthermore, the invention of claim 2 is characterized in that in the invention of claim 2 the specific region is a region where a feature image of the watermark pattern is present.

Furthermore, the invention of claim 3 is characterized in that in the invention of claim 1, the identification means comprises distinctive feature value extracting means for extracting as the value of distinctive feature the area or center of gravity of the watermark pattern present in the image of the specific region.

Furthermore, the invention of claim 4 is characterized in that in the invention of claim 1, the image processing means comprises watermark region center-of-gravity calculating means for calculating the center of gravity of the watermark region, and watermark region dividing means for dividing the image of the watermark region into a plurality of regions, with the center of gravity calculated with the watermark region center-of-gravity calculating means as the origin.

Furthermore, the invention of claim 5 is characterized in that in the invention of claim 1, the watermark region extracting means binarizes the image of the sheet based on a watermark region extraction threshold and extracts the watermark region based on the binarized image of the sheet.

Furthermore, the invention of claim 6 is characterized in that in the invention of claim 5, where the watermark region extraction threshold is set to a value between the quantity of light transmitted through the watermark region and the quantity of light transmitted through a region other than the watermark region.

Furthermore, the invention of claim 7 is characterized by comprising irradiating a sheet with a transmission light, acquiring an image of the sheet based on the transmitted light, extracting an image of a watermark region where a watermark pattern of the sheet is present from the acquired image, dividing the image of the extracted watermark region into a plurality of regions, and identifying the sheet based on a value of distinctive feature of the image contained in a specific region among the plurality of divided regions.

Furthermore, the invention of claim 8 is characterized in that in the invention of claim 7, the specific region is a region where a feature image of the watermark pattern is present.

Furthermore, the invention of claim 9 is characterized in that in the invention of claim 7, the area or center of gravity of the watermark pattern present in the image of the specific region is extracted as the value of distinctive feature.

Furthermore, the invention of claim 10 is characterized in that in the invention of claim 7, the center of gravity of the watermark region is calculated when the watermark region is divided into a plurality of regions, and the image of the watermark region is divided into a plurality of regions by using the calculated center of gravity as the origin.

Furthermore, the invention of claim 11 is characterized in that in the invention of claim 7, where the image of the sheet is binarized based on a watermark region extraction threshold when the watermark region is extracted, and the watermark region is extracted based on the binarized image of the sheet.

Furthermore, the invention of claim 12 is characterized in that in the invention of claim 11, the watermark region extraction threshold is set to a value between the quantity of light transmitted through the watermark region and the quantity of light transmitted through a region other than the watermark region.

### BRIEF DESCRIPTION OF THE DRAWINGS

FIG. 1 is a block diagram illustrating an example of the functional configuration of the sheet identifying device 1 of the present invention;

FIG. 2 is a block diagram illustrating an example of the functional configuration of the identification section 7;

FIG. 3 is a flowchart illustrating the processing procedure carried out by the sheet identifying device 1 when identifying the kind of the inserted sheet and checking whether the sheet is a genuine or a counterfeit one;

FIG. 4 illustrates the processing of the image data 20 of the captured region of the sheet carried out by the identification section 7;

FIG. 5 illustrates the processing of the image data 20 of the captured region of the sheet carried out by the identification section 7;

FIG. 6 illustrates the processing of the image data 20 of the captured region of the sheet carried out by the identification section 7 when wrinkles or stains (261, 262, 263) is present on the sheet; and

FIG. 7 illustrates outlines of the conventional method for detecting a watermark pattern.

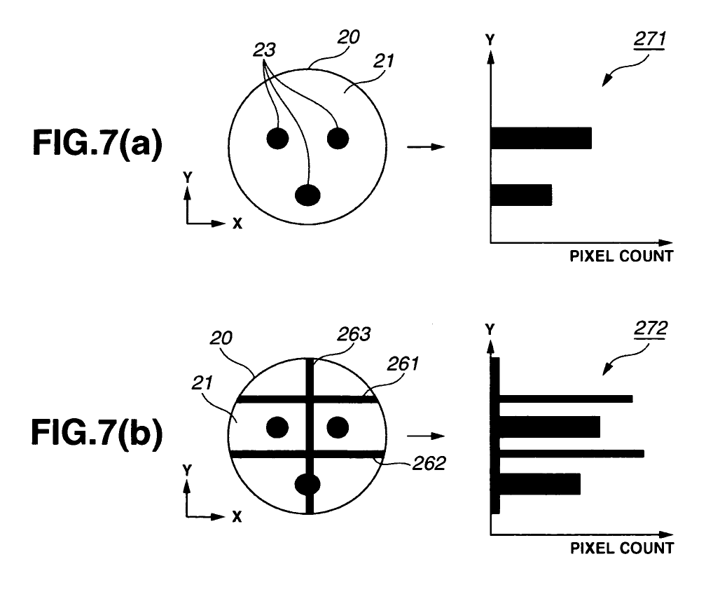

### BEST MODE FOR CARRYING OUT THE INVENTION

The embodiments of the sheet identifying device and method in accordance with the present invention will be described below in greater detail with reference to the appended drawings.

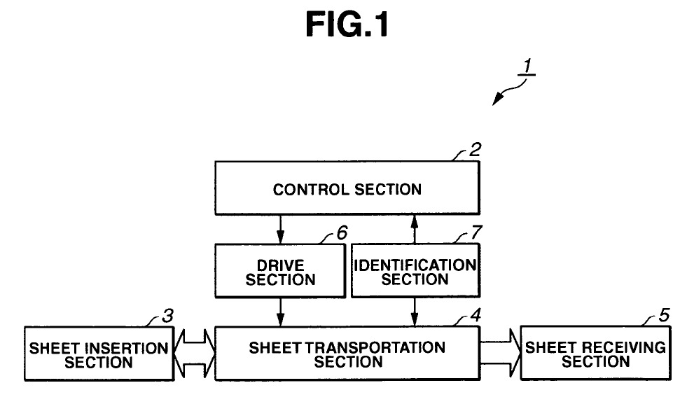

FIG. 1 is a block diagram illustrating an example of a functional structure of a sheet identifying device 1 in accordance with the present invention.

As shown in FIG. 1, the sheet identifying device 1 comprises a control section 2 for controlling the entire sheet identifying device 1, a sheet insertion section 3 that is a sheet insertion port, a sheet transporting section 4 for transporting the sheet, a sheet receiving section 5 for accepting the sheet, a drive section 6 for driving the sheet transporting section 4 under control from the control section 2, and an identification section 7 for identifying the kind of the sheet and whether the sheet is a genuine or a counterfeit one.

Functional operations performed by the sheet identifying device 1 for identifying the kind of the inserted sheet and whether the sheet is a genuine or a counterfeit one will be explained below.

If a sheet is inserted from the sheet insertion section 3, the sheet is transported by the sheet transporting section 4 under control of the drive section 6 by the control section 2. Here, the identification section 7 identifies the kind of the sheet transported by the sheet transporting section 4 and whether the sheet is a genuine or a counterfeit one, and when the sheet is identified as a genuine, the control section 2 drives the sheet transporting section 4 by controlling the drive section 6, the sheet is transported to the sheet receiving section 5, and the sheet is accepted, but when the sheet is identified as a counterfeit one, the control section drives the sheet transporting section 4 by controlling the drive section 6, the sheet is transported to the sheet insertion section 3, and the sheet is rejected.

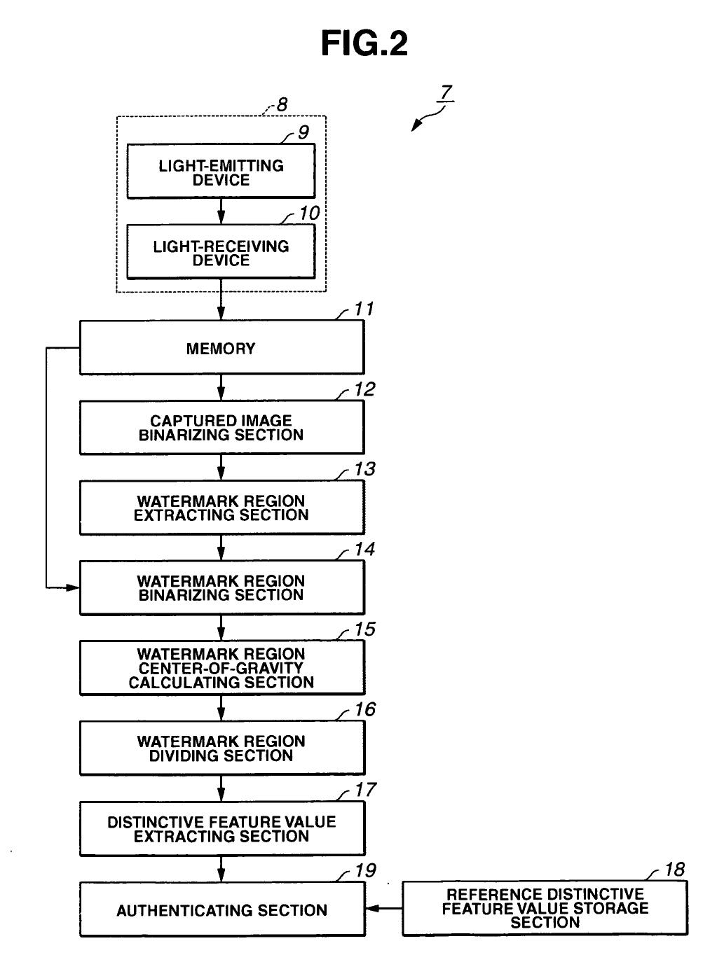

FIG. 2 is a block diagram illustrating an example of the functional configuration of the identification section 7.

As shown in FIG. 2, the identification section 7 comprises a transmission type optical sensor 8, a memory 11, a captured image binarizing section 12, a watermark region extracting section 13, a watermark region binarizing section 14, a watermark region center-of-gravity calculating section 15, a watermark region dividing section 16, a distinctive feature value extracting section 17, a reference distinctive feature value storage section 18, and an authenticating section 19.

Here, the transmission type optical sensor 8 comprises a pair of a light-emitting device 9 and a light-receiving device 10 arranged so as to sandwich the sheet transporting section 4. The transmission type optical sensor is disposed on the prescribed scanning line passing through a capturing region comprising a watermark region of the sheet that is an identification object. The light-emitting device 9 emits light onto the capturing region of the sheet, which is being transported by the sheet transporting section 4, and the light-receiving device 10 receives the transmitted light that was transmitted through the capturing region of the sheet and outputs an electric signal corresponding to the quantity of the received transmitted light. Incidentally, any of infrared, ultraviolet and visible light can be applied to the transmission type optical sensor 8.

Furthermore, the memory 11 conducts digital conversion of the signal level of the electric signals outputted with the prescribed time intervals from the transmission type optical sensor 8, successively stores the digital signals corresponding to the obtained signal levels in the prescribed storage area, allocates continuous addresses, and temporarily stores and retains the signals as image data of the captured region of the sheet.

Furthermore, the captured image binarizing section 12 reads image data of the captured region of the sheet that has been stored and retained by the memory 11 and conducts binarization of the read-out images based on a watermark region extraction threshold. Here, in order to extract the watermark region contained in the captured region, the values in the watermark region extraction threshold are set such that a pixel value of the watermark region is “0” and a pixel value of the usual region other than the watermark region is “1”.

The watermark region extracting section 13 extracts the watermark region contained in the captured region based on the image data binarized with the captured image binarizing section 12.

Furthermore, the watermark region binarizing section 14 conducts binarization of image data in the watermark region extracted with the watermark region extracting section 13 based on a watermark pattern extraction threshold. Here, in order to extract the watermark pattern contained in the watermark region, the values in the watermark pattern extraction threshold are set such that a pixel value of the watermark region is “0” and a pixel value of the watermark pattern is “1”.

Furthermore, the watermark region center-of-gravity calculating section 15 calculates the center of gravity of the watermark region.

The watermark region dividing section 16 divides the watermark region into a plurality of regions based on the center of gravity of the watermark region computed with the watermark region center-of-gravity calculating section 15.

The distinctive feature value extracting section 17 takes out the preset specific regions from inside the regions divided by the watermark region dividing section 16 and extracts value of distinctive feature such as center of gravity or area of a watermark pattern or part thereof that is present in the specific region that was taken out.

Values of distinctive features of a watermark pattern or part thereof that is present in the genuine specific region of a sheet are stored in advance as standard data by the reference distinctive feature value storage section 18 for each kind of the sheets.

The authenticating section 19 identifies the kind of sheet and checks whether the sheet is a genuine or a counterfeit one by comparing the value of distinctive feature extracted by the distinctive feature value extracting section 17 and the standard data stored in the reference distinctive feature value storage section 18.

Functional operation performed by the identification section 7 for identifying the kind of sheet and checking whether the sheet is a genuine or a counterfeit one will be explained below.

The sheet inserted from the sheet insertion section 3 is transported by the sheet transporting section 4, and when the sheet arrives to the arrangement position of the transmission type optical sensor 8, the light-emitting device 9 irradiates a capturing region of the sheet with light, the light-receiving device 10 receives the transmitted light that was transmitted through the capturing region of the sheet, and an electric signal is outputted to the memory 11 correspondingly to the quantity of the transmitted light that was received. If the electric signal is inputted into the memory 11, the signal level of the inputted electric signal is temporarily stored and retained as image data of the captured region of the sheet. The captured image binarizing section 12 reads the image data stored and retained in the memory 11, conducts binarization of the image data read out based on the watermark region extraction threshold, and sends the binarized image data to the watermark region extracting section 13. If the watermark region extracting section 13 receives the binarized image data, it extracts the watermark region based on the received binarized image data and sends information relating to the extracted watermark region to the watermark region binarizing section 14. When the watermark region binarizing section 14 receives the information relating to the watermark region, it reads the image data stored and retained in the memory 11, extracts only the image data of the watermark region from the image data that was read out, conducts binarization of the image data of the extracted watermark region based on the watermark pattern extraction threshold, and sends the binarized image data of the watermark region to the watermark region center-of-gravity calculating section 15. When the watermark region center-of-gravity calculating section 15 receives the binarized image data of the watermark region, it calculates the center of gravity of the watermark region and sends the calculated center of gravity of the watermark region and image data of the watermark region to the watermark region dividing section 16. When the watermark region dividing section 16 receives the center of gravity of the watermark region and image data of the watermark region, it divides the received image data of the watermark region into a plurality of regions with the received center of gravity of the watermark region as the origin and sends the image data of the watermark region divided into a plurality of regions to the distinctive feature value extracting section 17. When the distinctive feature value extracting section 17 receives the image data of the watermark region divided into a plurality of regions, it takes out the image data of the preset specific region, extracts value of distinctive feature such as center of gravity and area of the watermark pattern or part thereof that is present in the image data of the specific region that was taken out, and sends the extracted value of distinctive feature to the authenticating section 19. When the authenticating section 19 receives the value of distinctive feature, it identifies the kind of the sheet and checks whether the sheet is a genuine or a counterfeit one by comparing the received value of distinctive feature with the standard data stored in the reference distinctive feature value storage section 18.

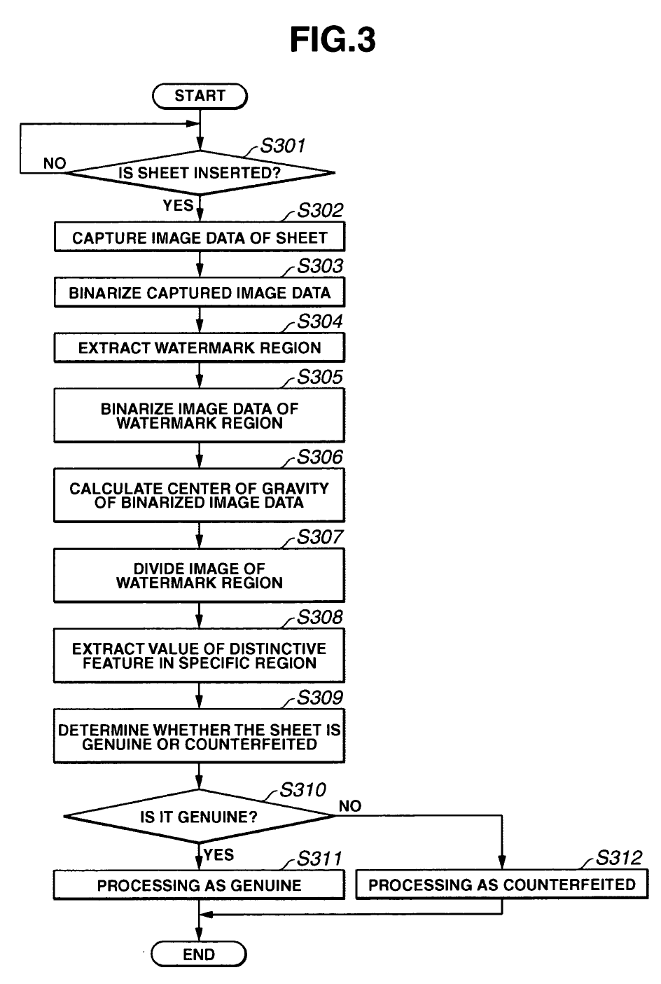

A processing procedure carried out by the sheet identifying device 1 for identifying the kind of the inserted sheet and whether the sheet is a genuine or a counterfeit one will be described below with reference to a flowchart shown in FIG. 3.

In the sheet identifying device, if a sheet is inserted from a sheet insertion section (step S301, YES), the image of the sheet is captured using a transmission type optical sensor (step S302), binarization of the captured image of the sheet is conducted based on the preset watermark region extraction threshold (step S303), a watermark region is extracted from the binarized image (step S304), only the image data of the watermark region is taken out from the captured image of the sheet and the image of the watermark region that was taken out is binarized based on a watermark pattern extraction threshold (step S305), the center of gravity of the binarized watermark region is calculated (step S306), the image of the watermark region is divided into a plurality of regions with the calculated center of gravity of the watermark region as the origin (step S307), value of distinctive feature in the preset specific region is extracted (step S308), whether the sheet is a genuine or a counterfeit one is checked based on the extracted value of distinctive feature (step S309), the sheet is accepted in the sheet receiving section (step S311) when the sheet is identified as a genuine one (YES in step S310), and processing procedure is ended.

Furthermore, when the sheet is identified as a counterfeit one in step S310 (NO in step S310), the sheet is rejected from the sheet insertion section (step S312) and the processing procedure is ended.

A method for sheet identification according to the present invention, which is carried out by the identification section 7, will be described below in greater detail.

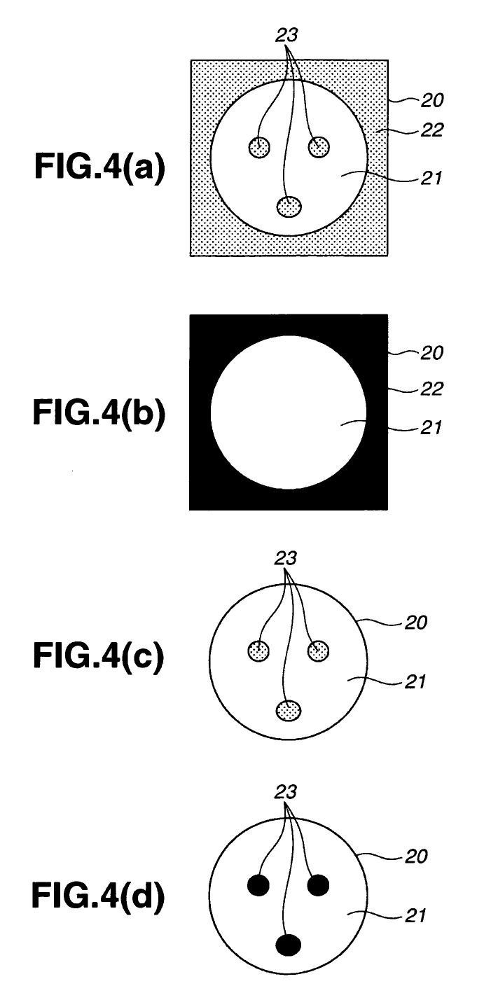

FIG. 4 illustrates the processing of image data 20 of the captured region of the sheet carried out by the identification section 7.

FIG. 4(a) illustrates an example of the image data of the captured region of the sheet that was captured with the transmission type optical sensor 8. As shown in FIG. 4(a), a watermark region 21 and a usual region 22 other than the watermark region are present inside the capturing region of the sheet and a plurality of watermark patterns 23 are present in the watermark region 21. Here, the quantity of light that passes through the watermark region 21 is large, the quantity of light that passes through the watermark patterns 23 is less than that of the watermark region 21, and the quantity of light passing through the usual region 22 is less than that of the watermark patterns 23.

Here, a value between the quantity of light of the watermark pattern 23 and the quantity of light of the usual region 22 is set as a watermark region extraction threshold and the image data 20 shown in FIG. 4(a) are binarized based on this threshold in order to obtain the watermark region 21 and watermark pattern 23 as white pixels (pixel value is “0”) and the usual region 22 as black pixels (pixel value is “1”) when the watermark region (including the watermark patterns) 21 is extracted from the image data of the captured region of the sheet.

FIG. 4(b) shows an example of the image data 20 obtained by binarizing the image data 20 shown in FIG. 4(a) based on the watermark region extraction threshold. As shown in FIG. 4(b), because the image data 20 are binarized based on the watermark region extraction threshold, the watermark region 21 and watermark pattern 22 become white pixels, the usual region 22 becomes black pixels, and the watermark region 21 can be extracted based on the binarized image data 20.

FIG. 4(c) shows an example of image data 20 obtained by extracting the watermark region 21 of the image data 20 shown in FIG. 4(a). Here, a value between the quantity of light of the watermark region 21 and the quantity of light of the watermark pattern 23 is set as a watermark pattern extraction threshold and the image data 20 shown in FIG. 4(c) are binarized based on the threshold in order to obtain the watermark region 21 as white pixels and the watermark pattern 23 as black pixels when the watermark pattern 23 is extracted from the image data 20 shown in FIG. 4(c).

FIG. 4(d) shows an example of the image data 20 obtained by binarizing the image data 20 shown in FIG. 4(c) based on the watermark pattern extraction threshold. As shown in FIG. 4(d), because the image data 20 are binarized based on the watermark pattern extraction threshold, the watermark region 21 becomes a white pixel and the watermark pattern 23 becomes black pixels, and the watermark pattern 23 can be extracted based on the binarized image data 20.

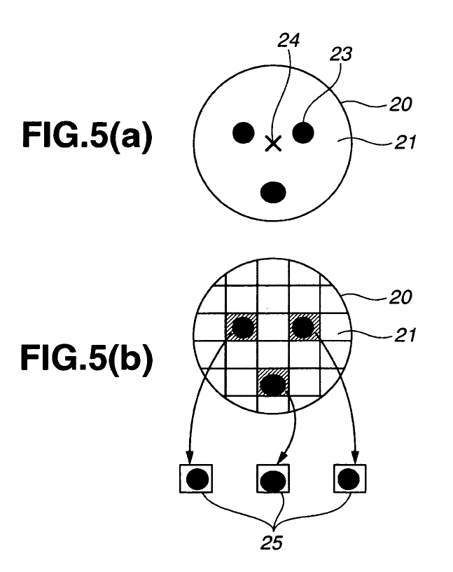

FIG. 5 illustrates the processing of the image data 20 of the captured region of the sheets implemented by the identification section 7.

As shown in FIG. 5(a), the center of gravity 24 of the watermark region 21 is calculated, and the image data 20 obtained by extracting the watermark region 21 are divided into a plurality of regions by using the calculated center of gravity 24 as the origin.

FIG. 5(b) shows an example of the image data obtained by dividing the image data 20 obtained by extracting the watermark region 21 into a plurality of regions by using the center of gravity 24 as the origin. As shown in FIG. 5(b), the image data 20 are divided between a plurality of regions of arbitrary shape, a region where the watermark pattern is present is taken out as a specific region 25, and value of distinctive feature of the watermark pattern 23 in the specific region 25 that was taken out is extracted. Here, for example, the area and center of gravity of the watermark pattern 23 in the specific region 25 are extracted as the value of distinctive feature (the value of distinctive feature is not limited to the area and center of gravity and include those that can be found arithmetically).

The shape of the divided regions is not limited to the rectangular shape shown in FIG. 5(b) and the application is possible with any shape.

Furthermore, the kind of the sheet is identified and whether the sheet is a genuine or a counterfeit one is checked by comparing the extracted value of distinctive feature with reference value of distinctive feature extracted from the genuine sheet that were stored in advance.

A method for identifying a sheet in accordance with the present invention that is conducted by the identification section 7 in the case where wrinkles and stains are present on the sheet will be explained below in greater detail.

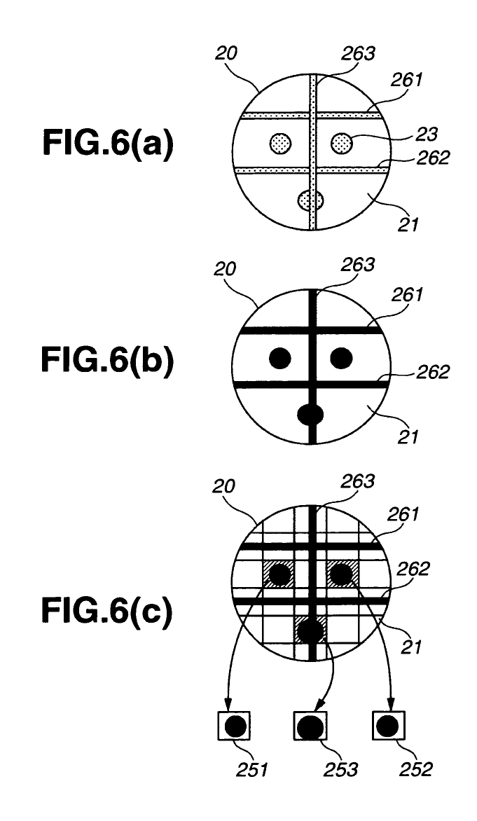

FIG. 6 illustrates the processing of the image data 20 of the captured region of the sheet conducted by the identification section 7 in the case where wrinkles and stains (261, 262, 263) are present on the sheet.

FIG. 6(a) shows an example of image data 20 of the sheet where wrinkles and stains (261, 262, 263) are present. As shown in FIG. 6(a) a plurality of watermark patterns 23 together with the wrinkles and stains (261, 262, 263) are present inside the watermark region 21. Here, the quantity of light that passes through the watermark region 21 is large, the quantity of light that passes through the watermark patterns 23 is less than that of the watermark region 21, and the quantity of light passing through the wrinkles and stains (261, 262, 263) is empirically almost equal to that of the watermark patterns 23. The image data 20 shown in FIG. 6(a) are binarized based on the watermark pattern extraction threshold.

FIG. 6(b) shows an example of the image data 20 obtained by binarizing the image data 20 shown in FIG. 6(a) based on the watermark pattern extraction threshold. As shown in FIG. 6(b), the watermark region 21 and watermark pattern 22 become white pixels and the watermark pattern 23 and wrinkles and stains (261, 262, 263) become black pixels. The image data 20 are then divided into a plurality of regions by employing the center of gravity of the watermark region 21 as the origin.

FIG. 6(c) shows an example of the image data 20 relating to separation of the watermark patterns 23 by dividing the image data 20 shown in FIG. 6(b) into a plurality of regions by employing the center of gravity as the origin. As shown in FIG. 6(c), if the image data 20 are divided into a plurality of regions of arbitrary shape and the regions where the watermark pattern 23 is present are taken out as specific regions (251, 252, 253), then the region where two wrinkles and stains (261, 262) are present will not be taken out as specific regions (251, 252, 253). Therefore, those two wrinkles and stains (261, 262) produce no effect. Furthermore, wrinkles and stains 263 are present in the specific region 253, but because the area occupied by the wrinkles and stains 263 in the specific region 253 is small, the effect of wrinkles and stains 263 is insignificant.

Therefore, the effect of wrinkles and stains can be minimized, the kind of sheet can be accurately identified, and whether the sheet is a genuine or a counterfeit can be checked accurately.

Furthermore, in actual identification of sheets, the complete check of the sheets may be carried out based on a combination with many identification factors rather than identifying the kind of sheet and checking whether the sheet is a genuine or a counterfeit one only with the sheet identifying method in accordance with the present invention.

### INDUSTRIAL APPLICABILITY

With the present invention, when a sheet is identified based on image data obtained by capturing the watermark patterns of the sheet, it is possible to identify the kind of sheet and check whether the sheet is a genuine or a counterfeit with good stability by minimizing the effect produced by wrinkles and stains present on the sheet on the image data. Furthermore, the accuracy of identifying the sheets with elaborate patterns is also increased.

1. A sheet identifying device comprising:
a transmission type optical sensor that irradiates a sheet with transmission light and acquiring an image of the sheet based on transmitted light;
watermark region extracting means for extracting an image of a watermark region where a watermark pattern is present from the image acquired with the transmission type optical sensor;
image processing means for dividing the image of the watermark region extracted with the watermark region extracting means into a plurality of regions; and
identification means for identifying the sheet based on a value of distinctive feature of the image contained in a specific region among the plurality of regions obtained by dividing with the image processing means.

2. The sheet identifying device according to claim 1, wherein
the specific region is a region where a feature image of the watermark pattern is present.

3. The sheet identifying device according to claim 1, wherein
the identification means comprises distinctive feature value extracting means for extracting area or center of gravity of the watermark pattern present in the image of the specific region as the value of distinctive feature.

4. The sheet identifying device according to claim 1, wherein
the image processing means comprises:
watermark region center-of-gravity calculating means for calculating center of gravity of the watermark region; and
watermark region dividing means for dividing the image of the watermark region into a plurality of regions, with the center of gravity calculated with the watermark region center-of-gravity calculating means as an origin.

5. The sheet identifying device according to claim 1, wherein
the watermark region extracting means binarizes the image of the sheet based on a watermark region extraction threshold and extracts the watermark region based on the binarized image of the sheet.

6. The sheet identifying device according to claim 5, wherein
the watermark region extraction threshold is set to a value between quantity of light transmitted through the watermark region and quantity of light transmitted through a region other than the watermark region.

7. A sheet identifying method comprising:
irradiating a sheet with a transmission light;
acquiring an image of the sheet based on transmitted light;
extracting an image of a watermark region where a watermark pattern of the sheet is present from the acquired image;
dividing the image of the extracted watermark region into a plurality of regions; and
identifying the sheet based on a value of distinctive feature of the image contained in a specific region among the plurality of divided regions.

8. The sheet identifying method according to claim 7, wherein
the specific region is a region where a feature image of the watermark pattern is present.

9. The sheet identifying method according to claim 7, wherein
area or center of gravity of the watermark pattern present in the image of the specific region is extracted as the value of distinctive feature.

10. The sheet identifying method according to claim 7, wherein
center of gravity of the watermark region is calculated when the watermark region is divided into the plurality of regions, and
the image of the watermark region is divided into a plurality of regions with the calculated center of gravity as an origin.

11. The sheet identifying method according to claim 7, wherein
the image of the sheet is binarized based on a watermark region extraction threshold when the watermark region is extracted; and
the watermark region is extracted based on the binarized image of the sheet.

12. The sheet identifying method according to claim 11, wherein
the watermark region extraction threshold is set to a value between quantity of light transmitted through the watermark region and quantity of light transmitted through a region other than the watermark region.
